(19) United States
(12) Patent Application Publication
(10) Pub. No.: US 2022/0137997 A1
(43) Pub. Date: May 5, 2022

(54) PLATFORM UPDATE USING SELF-INSTALLING CONTAINERIZED MICROSERVICE

(71) Applicant: Citrix Systems, Inc., Fort Lauderdale, FL (US)

(72) Inventors: John Victor Baboval, Littleton, MA (US); Elias Amissao Mendes Calocane, Cambridge (GB); Stefano Panella, Cambridge (GB); Simon John Rowe, Ely (GB)

(21) Appl. No.: 17/088,708

(22) Filed: Nov. 4, 2020

(51) Int. Cl. G06F 9/455; G06F 9/445; G06F 11/14

(52) U.S. Cl. CPC G06F 9/45558; G06F 9/44505; G06F 2009/45579; G06F 11/1469; G06F 11/1451

(57) ABSTRACT

A system and method for self-installing a container platform. A method includes implementing an active version and a passive version of the container platform, wherein the active version actively runs on a computing infrastructure and the passive version is maintained in a storage area; loading an updater container from a container registry containing updates to the container platform into the container engine; running the updater container in the container engine, including: mapping the passive version from the storage area to the updater container, writing update data to the passive version, installing the passive version as a new active version, and rebooting the host operating system.

### BACKGROUND OF THE DISCLOSURE

Container based environments, such as Docker®, provide a virtualized platform to create, deploy and run applications using containers. In such an environment, applications are packaged in containers that include a de facto runtime allowing applications to be portable among any system running a selected host operating system (OS), such as Linux or Windows. To achieve this, a container engine sits on top of the host OS allowing different containers to run and share the OS kernel in isolation from one another, e.g., as microservices. In contrast, virtual machines (VMs) require the OS to be incorporated into each VM, which adds significant overhead in creating and maintaining applications.

### BRIEF DESCRIPTION OF THE DISCLOSURE

Aspects of this disclosure provide a system and method that utilizes a containerized microservice (i.e., container) to update the container platform.

A first aspect of the disclosure provides a method for updating a container platform having a host operating system and a container engine. The method includes implementing an active version and a passive version of the container platform, wherein the active version actively runs on a computing infrastructure and the passive version is maintained in a storage area; and loading an updater container from a container registry containing updates to the container platform into the container engine. Once loaded, the updater container is run which then maps the passive version from the storage area to the updater container, writes update data to the passive version, installs the passive version as a new active version, and reboots the host operating system.

A second aspect of the disclosure provides a container system, comprising: a memory and a processor configured to update a container platform having a host operating system and a container engine according to a method that includes implementing an active version and a passive version of the container platform, wherein the active version actively runs on a computing infrastructure and the passive version is maintained in a storage area. The update process includes loading an updater container from a container registry containing updates to the container platform into the container engine and running the updater container in the container engine. Running the updater container includes: mapping the passive version from the storage area to the updater container, writing update data to the passive version, installing the passive version as a new active version, and rebooting the host operating system.

A third aspect of the disclosure provides an updater container stored on computer storage medium, which when run by a container platform that includes a container engine and host operating system, performs a method that updates the container platform. The method includes: mapping a passive version of the container platform to the updater container; writing update data to the passive version of the container platform; installing the passive version as a new active version of the container platform; and rebooting the host operating system to cause the new active version of the container platform to run.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative container-based system, in accordance with an illustrative embodiment.

FIG. 2 depicts an illustrative container-based system configure to perform self-updates, in accordance with an illustrative embodiment.

FIG. 3 depicts a system flow diagram of an illustrative self-update process, in accordance with an illustrative embodiment.

FIG. 4 depicts a flow diagram of a container updater process, in accordance with an illustrative embodiment.

FIG. 5 depicts a network infrastructure, in accordance with an illustrative embodiment.

FIG. 6 depicts a cloud computing diagram, in accordance with an illustrative embodiment.

FIG. 7 depicts a computing system, in accordance with an illustrative embodiment.

The drawings are intended to depict only typical aspects of the disclosure, and therefore should not be considered as limiting the scope of the disclosure.

### DETAILED DESCRIPTION OF THE DISCLOSURE

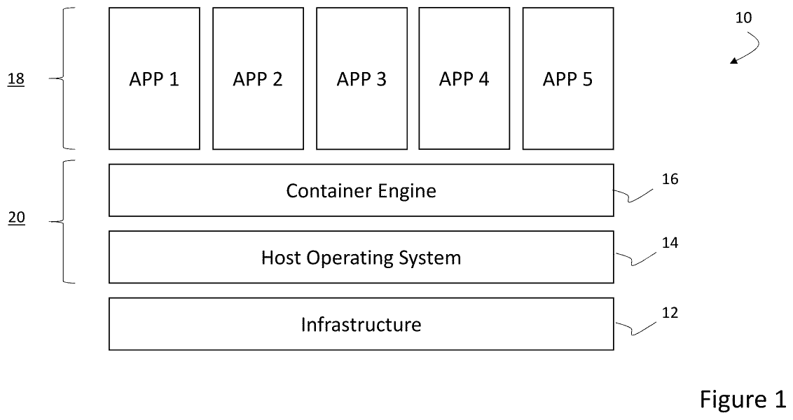

Embodiments of the disclosure provide technical solutions for updating a container platform within a container-based system. In certain embodiments, a self-installing container is utilized to install the container platform, which may include a container engine and host operating system (OS). As noted, container-based systems provide an efficient platform for creating, managing and deploying applications. In such an environment, applications are packaged in containers that are decoupled from the underlying host operating system (OS) using the container engine, which sits on top the host OS and is responsible for creating and running containers. An illustrative container-based system 10 is shown in FIG. 1, which generally includes a computing infrastructure 12, a host operating system 14, a container engine 16 and a set of containerized applications held in “containers” 18.

In the past, updating the container platform 20, i.e., the container engine 16 and the host operating system 14, introduced significant technical complexities, as both the platform 20 and the containers 18 needed to be carefully managed during the update, i.e., each component needed to be separately stored, transferred, validated, etc., during the process. Additionally, code for extracting and updating the platform 20 had to be at least partially present on the existing platform in order for an upgrade to be installed. The present approach overcomes these technical challenges by packaging updates as container images that self-install a new platform 20.

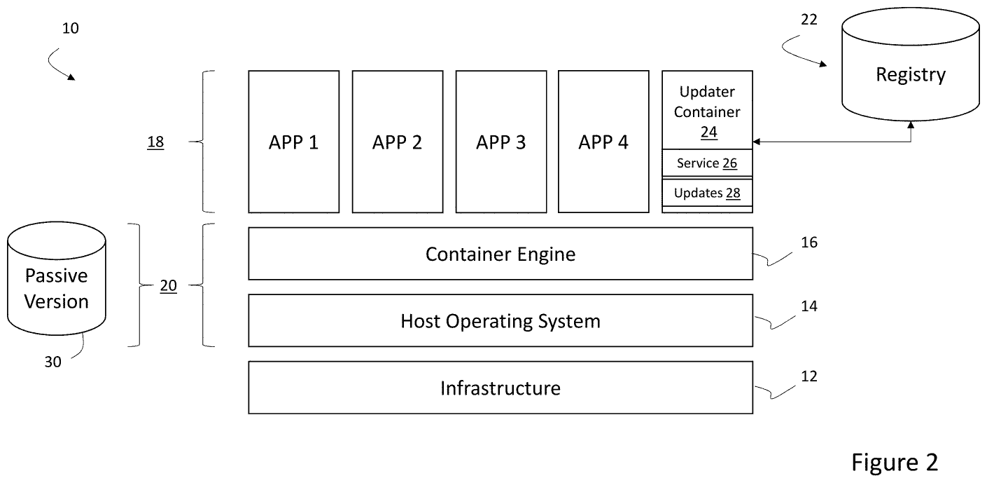

An illustrative embodiment of the current system is shown in FIG. 2, in which an updater container 24 is loaded from a container registry 22 and run by container engine 16 just like any other container 18. In this approach, an update service 26 within the updater container 24 extracts and installs platform updates 28, which are also packaged in the updater container 24. Accordingly, new releases containing updates 28 are simply uploaded to the container registry 22 alongside other containerized services, and then downloaded and run. Once run, the update service 26 inside the updater container 24 self-installs the new version of the container engine 16 and host operating system 14.

To perform the self-install process, the platform 20 uses an embedded system style active/passive dual image upgrade model. In this case, a passive version 30 of the platform 20 is maintained in storage in addition to the active version that is actively running on the computing infrastructure 12. When the updater container 24 is run, the passive version 30 is mapped into the updater container 24, e.g., as a volume, and updates 28 are written to the passive image 30. Once completed, the service 26 installs the new version, stops the updater container 24 and reboots the host operating system 14 into the newly installed version.

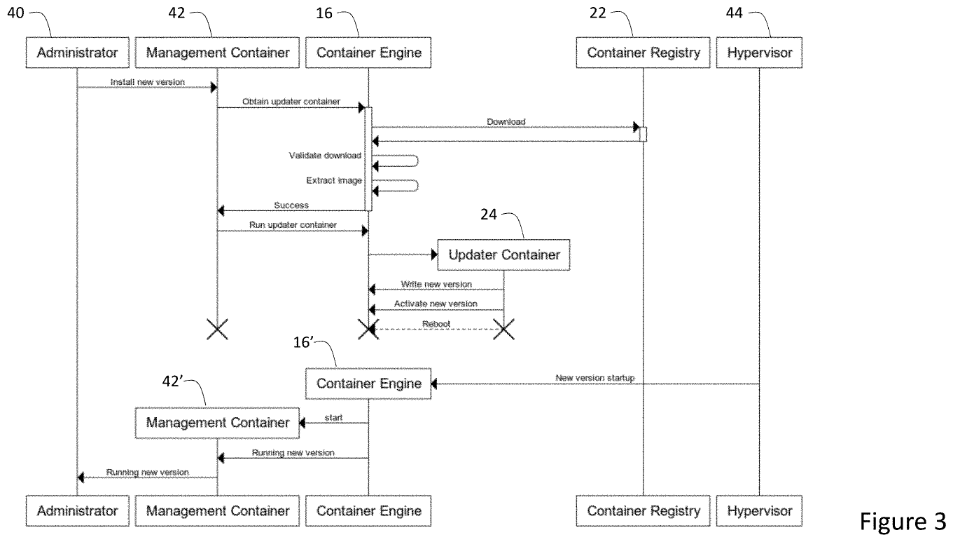

FIG. 3 depicts a system level flow diagram of an illustrative update process (with reference to FIG. 2). The process begins with an administrator 40 instructing a management container 42 to install a new version of the platform 20. The management container 42 in turn instructs the container engine 16 to download the updater container 24 from the container registry 22. The container engine 16 then downloads the updater container 24 from the container registry 22, validates the download and extracts a container image with the update service 26 and updates 28 (FIG. 2). Once successfully extracted, the management container 42 instructs the container engine 16 to run the updater container 24. The updater container 24 writes a new version of the platform 20 (utilizing the passive version 30), activates the new version, and reboots. In response to the reboot, hypervisor 44 starts up the new version of the container engine 16, completing the installation.

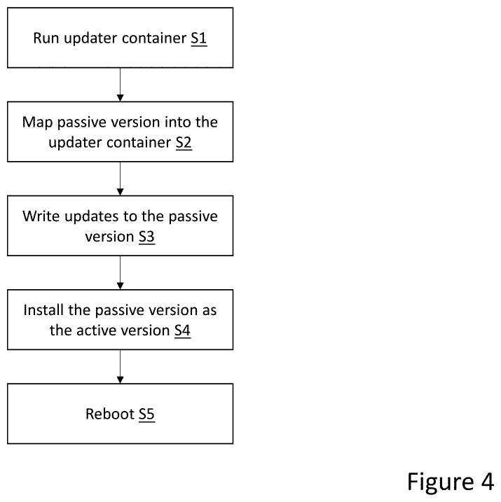

FIG. 4 depicts a flow diagram showing illustrative logic utilized by the updater container 24 (also with reference to FIG. 2). At S1, the updater container 24 is run by the container engine 16. Next, at S2, the passive version 30 of the platform 20 is mapped into the updater container 24. Volume mapping is a common function of container platforms. In this case, the container engine 16 is instructed to map the passive volume device node into the container as configuration for the container. For example, the “docker run” command accepts a list of volumes specified as their address or path in the host environment, and the path they should be mapped to inside the container environment, e.g., docker run-v/dev/passive-instance-block-device:/dev/device-to-update my-image:latest.

At S3, updates 28 are written to the passive version 30 and once complete, the passive version is installed as the active version at S4 and the operating system is rebooted at S5, e.g., based on an updated boot configuration. The boot configuration is stored in a configuration file in the platform Extensible Firmware Interface (EFI) partition. The EFI system partition is a partition on a data storage device that is used by computers adhering to the Unified Extensible Firmware Interface. When a computer is booted, UEFI firmware loads files stored on the Extensible System Partition to start installed operating systems and various utilities. The configuration specifies which installation should be considered the default, such that the bootloader will attempt to use the configured volume, and fall back to the other in the case of failure. When this process installs a new instance of the container platform, the default value is changed to indicate the newly written volume as the final step of the update before reboot. In response to the reboot, the new version of the platform 20 is run.

After the update is validated, the passive version 30 may or may not be updated depending on the implementation. In some embodiments, the passive version 30 may contain a replicate of the prior active version. In other embodiments, the passive version 30 may contain a replicate of the new active version.

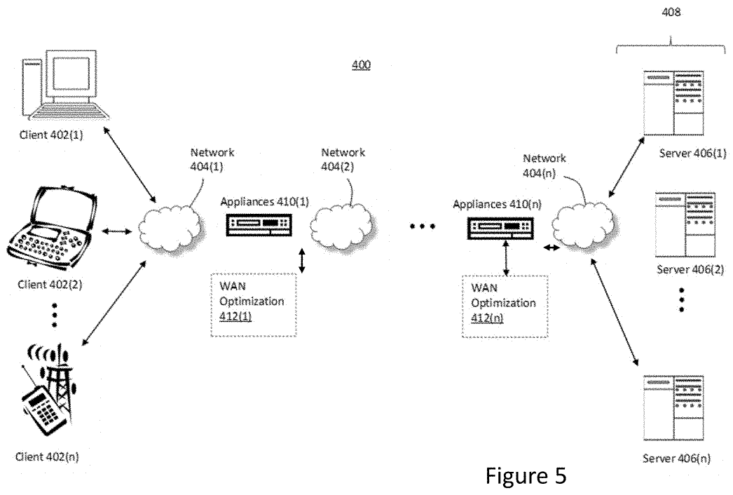

Referring to FIG. 5, an illustrative network environment 400 is depicted suitable for implementing aspects of a container-based system. Network environment 400 may include one or more clients 402(1)-402(n) (also generally referred to as local machine(s) 402 or client(s) 402) in communication with one or more servers 406(1)-406(n) (also generally referred to as remote machine(s) 406 or server(s) 406) via one or more networks 404(1)-404n (generally referred to as network(s) 404). In some embodiments, a client 402 may communicate with a server 406 via one or more appliances 410(1)-410n (generally referred to as appliance(s) 410 or gateway(s) 410).

Although the embodiment shown in FIG. 5 shows one or more networks 404 between clients 402 and servers 406, in other embodiments, clients 402 and servers 406 may be on the same network 404. The various networks 404 may be the same type of network or different types of networks. For example, in some embodiments, network 404(1) may be a private network such as a local area network (LAN) or a company Intranet, while network 404(2) and/or network 404(n) may be a public network, such as a wide area network (WAN) or the Internet. In other embodiments, both network 404(1) and network 404(n) may be private networks. Networks 404 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 5, one or more appliances 410 may be located at various points or in various communication paths of network environment 400. For example, appliance 410(1) may be deployed between two networks 404(1) and 404(2), and appliances 410 may communicate with one another to work in conjunction to, for example, accelerate network traffic between clients 402 and servers 406. In other embodiments, the appliance 410 may be located on a network 404. For example, appliance 410 may be implemented as part of one of clients 402 and/or servers 406. In an embodiment, appliance 410 may be implemented as a network device such as Citrix networking (formerly NetScaler®) products sold by Citrix Systems, Inc. of Fort Lauderdale, Fla.

As shown in FIG. 5, one or more servers 406 may operate as a server farm 408. Servers 406 of server farm 408 may be logically grouped, and may either be geographically co-located (e.g., on premises) or geographically dispersed (e.g., cloud based) from clients 402 and/or other servers 406. In an embodiment, server farm 408 executes one or more applications on behalf of one or more of clients 402 (e.g., as an application server), although other uses are possible, such as a file server, gateway server, proxy server, or other similar server uses. Clients 402 may seek access to hosted applications on servers 406.

As shown in FIG. 5, in some embodiments, appliances 410 may include, be replaced by, or be in communication with, one or more additional appliances, such as WAN optimization appliances 412(1)-412(n), referred to generally as WAN optimization appliance(s) 412. For example, WAN optimization appliance 412 may accelerate, cache, compress or otherwise optimize or improve performance, operation, flow control, or quality of feature of network traffic, such as traffic to and/or from a WAN connection, such as optimizing Wide Area File Features (WAFS), accelerating Server Message Block (SMB) or Common Internet File System (CIFS). In some embodiments, appliance(s) 412 may be a performance enhancing proxy or a WAN optimization controller. In one embodiment, appliance 412 may be implemented as Citrix SD-WAN products sold by Citrix Systems, Inc. of Fort Lauderdale, Fla.

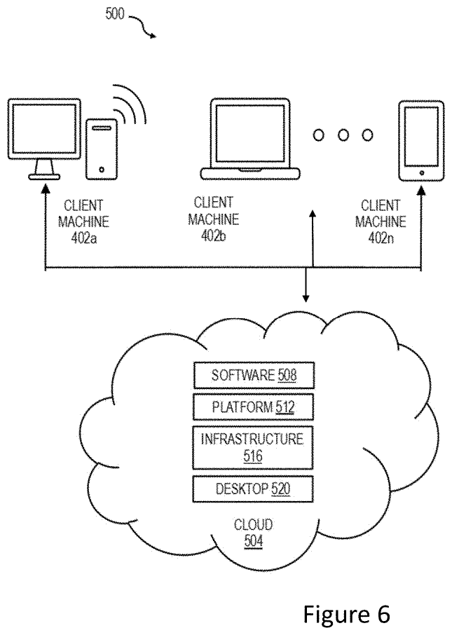

In described embodiments, clients 402, servers 406, and appliances 410 and 412 may be deployed as and/or executed on any type and form of computing device, such as any desktop computer, laptop computer, or mobile device capable of communication over at least one network and performing the operations described herein. For example, clients 402, servers 406 and/or appliances 410 and 412 may each correspond to one computer, a plurality of computers, or a network of distributed computers such as computing device 300 shown in FIG. 6.

Referring to FIG. 6, a cloud computing environment 500 is depicted, which may also be referred to as a cloud environment, cloud computing or cloud network. The cloud computing environment 500 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 500, one or more clients 402a-402n (such as those described above) are in communication with a cloud network 504. The cloud network 504 may include back-end platforms, e.g., servers, storage, server farms or data centers. The users or clients 402a-402n can correspond to a single organization/tenant or multiple organizations/tenants. More particularly, in one example implementation the cloud computing environment 500 may provide a private cloud serving a single organization (e.g., enterprise cloud). In another example, the cloud computing environment 500 may provide a community or public cloud serving multiple organizations/tenants.

In some embodiments, the described approach may be utilized to update a gateway appliance(s) or service, which may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 500 may provide a hybrid cloud that is a combination of a public cloud and a private cloud. Public clouds may include public servers that are maintained by third parties to the clients 402a-402n or the enterprise/tenant. The servers may be located off-site in remote geographical locations or otherwise.

The cloud computing environment 500 can provide resource pooling to serve multiple users via clients 402a-402n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 500 can provide on-demand self-service to unilaterally provision computing capabilities (e.g., server time, network storage) across a network for multiple clients 402a-402n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 500 can provide an elasticity to dynamically scale out or scale in response to different demands from one or more clients 402. In some embodiments, the cloud computing environment 500 can include or provide monitoring services to monitor, control and/or generate reports corresponding to the provided shared services and resources.

In some embodiments, the cloud computing environment 500 may provide cloud-based delivery of different types of cloud computing services, such as Software as a service (SaaS) 508, Platform as a Service (PaaS) 512, Infrastructure as a Service (IaaS) 516, and Desktop as a Service (DaaS) 520, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

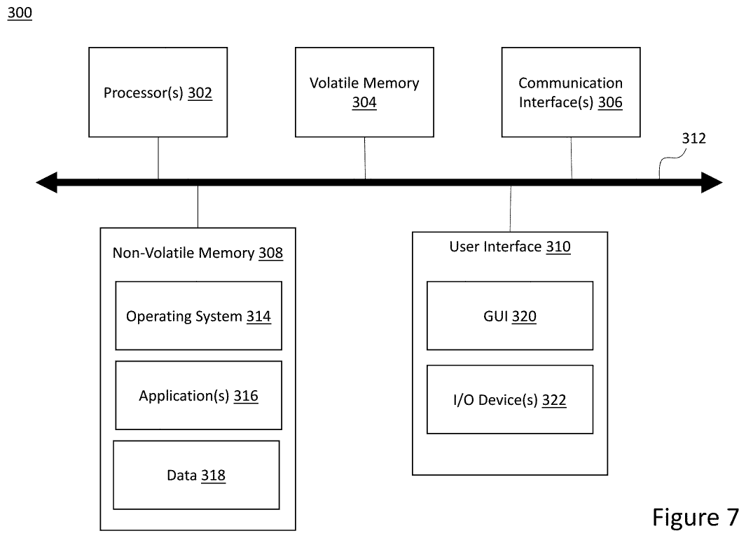

Elements of the described solution may be embodied in a computing system, such as that shown in FIG. 7 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 7 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method for updating a container platform having a host operating system and a container engine, comprising:
implementing an active version and a passive version of the container platform, wherein the active version actively runs on a computing infrastructure and the passive version is maintained in a storage area;
loading an updater container from a container registry containing updates to the container platform into the container engine; and
running the updater container in the container engine, including:
mapping the passive version from the storage area to the updater container,
writing update data to the passive version,
installing the passive version as a new active version, and
rebooting the host operating system.

2. The method of claim 1, wherein, in response to the rebooting, the new active version is launched to actively run on the computing infrastructure.

3. The method of claim 2, wherein, in response to the rebooting, the new active version is launched by a hypervisor.

4. The method of claim 2, further including creating a new passive version from one of a prior active version of the container platform or a new active version of the container platform.

5. The method of claim 2, wherein the new active version includes an updated container engine and an updated host operating system.

6. The method of claim 1, wherein loading the updater container occurs in response to an administrator instructing the container platform to install a new version of the container platform via a management container.

7. The method of claim 1, wherein at least one prior version of the container platform is saved as a backup version.

8. A container-based system, comprising:
a memory; and
a processor configured to update a container platform having a host operating system and a container engine according to a method that includes:
implementing an active version and a passive version of the container platform, wherein the active version actively runs on a computing infrastructure and the passive version is maintained in a storage area;
loading an updater container from a container registry containing updates to the container platform into the container engine; and
running the updater container in the container engine, including:
mapping the passive version from the storage area to the updater container,
writing update data to the passive version,
installing the passive version as a new active version, and
rebooting the host operating system.

9. The container-based system of claim 8, wherein, in response to the rebooting, launching the new active version to actively run on the computing infrastructure.

10. The container-based system of claim 9, wherein, in response to the rebooting, the new active version is launched by a hypervisor.

11. The container-based system of claim 9, wherein the method further includes creating one of a new passive version from a prior active version of the container platform or the new active version of the container platform.

12. The container-based system of claim 9, wherein the new active version includes an updated container engine and an updated host operating system.

13. The container-based system of claim 8, wherein loading the updater container occurs in response to an administrator instructing the container platform to install a new version of the container platform via a management container.

14. The container-based system of claim 8, wherein at least one prior version of the container platform is saved as a backup version.

15. An updater container stored on computer storage medium, which when run by a container platform that includes a container engine and host operating system, performs a method that comprises:
mapping a passive version of the container platform to the updater container;
writing update data to the passive version of the container platform;
installing the passive version as a new active version of the container platform; and
rebooting the host operating system to cause the new active version of the container platform to run.

16. The updater container of claim 15, wherein the method further includes creating a new passive version from at least one of a prior active version and the new active version.

17. The updater container of claim 15, wherein the new active version includes an updated container engine and an updated host operating system.

18. The updater container of claim 15, wherein the method further includes saving at least one prior version of the container platform as a backup version.

19. The updater container of claim 15, wherein installing the passive version as the new active version of the container platform includes providing a configuration file having a reference to a volume containing the new active version.

20. The update container of claim 19, wherein installing the passive version as the new active version includes updating the reference in the configuration file.
